(19) United States
(12) Patent Application Publication
(10) Pub. No.: US 2012/0228350 A1
(43) Pub. Date: Sep. 13, 2012

(54) APPARATUSES AND METHODS FOR PREVENTING LOSS OF WHEELCHAIR FOOT PEDALS

(76) Inventors: Johnathan Tyler Bennett, Arden, NC (US); David Ashby Griffith, Rock Hill, SC (US); Stephen Dana Paul Matichak, Acworth, GA (US); Dustin Lawrence George, Wesley Chapel, FL (US); Chip Wesley Ferguson, Cullowhee, NC (US)

(21) Appl. No.: 13/316,181

(22) Filed: Dec. 9, 2011

Related U.S. Application Data
(63) Continuation of application No. 13/094,513, filed on Apr. 26, 2011, now abandoned.
(60) Provisional application No. 61/328,001, filed on Apr. 26, 2010.

(51) Int. Cl. B60R 11/00

(52) U.S. Cl. 224/407

(57) ABSTRACT

Apparatuses and methods for preventing loss of one or more wheelchair foot pedals are disclosed. In one embodiment, a device for use with one or more wheelchair foot pedals includes a body comprising a storage portion. The device can further include at least one tethering device disposed within the body, the tethering device having a first connecting member connected to at least a first wheelchair foot pedal. The first wheelchair foot pedal can be movable from an attached position to a detached position. The first wheelchair foot pedal can be secured and/or placed into the storage portion of the apparatus when in the detached position.

### PRIORITY CLAIM

This application is a continuation of and claims priority to U.S. application Ser. No. 13/094,513 filed Apr. 26, 2011 which claims the benefit of and priority to U.S. Provisional Patent Application Ser. No. 61/328,001 filed on Apr. 26, 2010, the disclosures of which are incorporated herein by reference in its entireties.

### TECHNICAL FIELD

The presently disclosed subject matter relates generally to apparatuses and methods for preventing loss of wheelchair foot pedals. More particularly, the present subject matter relates to apparatuses and methods for detaching and retaining wheelchair foot pedals as a measure of preventing the pedals from being lost.

### BACKGROUND

In general, standard designs for the majority of wheelchairs utilize detachable foot pedals. It is not unusual for wheelchair users, for example, patients in hospitals to remove the foot pedals in order to use his or her feet to help propel the wheelchair. Oftentimes, patients require assistance from other individuals including nurses, family, or friends to help remove the foot pedals. Once the foot pedals become removed from the wheelchair, the removed pedals can easily become left behind and/or lost as the patient moves throughout the hospital. Thus, the standard design can cause wheelchair users to frequently lose or misplace the foot pedals after they become detached. This can be a problem for many wheelchair users and/or hospital staff and can increase costs associated with medical care.

### SUMMARY

In accordance with this disclosure, novel apparatuses and methods for preventing loss of wheelchair foot pedals are provided. It is, therefore, an object of the present disclosure to provide apparatuses and methods for improved detachment and storage of wheelchair foot pedals.

This and other objects of the present disclosure as can become apparent from the present disclosure are achieved, at least in whole or in part, by the subject matter described herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a perspective view of one embodiment of a wheelchair foot pedal tethering and storage device as described herein; and

FIGS. 2A and 2B illustrate portions of the wheelchair foot pedal tethering and storage device as installed on a wheelchair and/or wheelchair foot pedals as described herein;

FIG. 3 illustrates a rear perspective view of a wheelchair having a wheelchair foot pedal tethering and storage device installed thereon as described herein;

FIG. 4 illustrates a front perspective view of a wheelchair having a wheelchair foot pedal tethering and storage device installed thereon as described herein; and

FIG. 5 illustrates a tethering device as described herein.

### DETAILED DESCRIPTION

Reference will now be made in detail to the description of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the present subject matter cover such modifications and variations.

As illustrated in the figures, some sizes of structures or portions are exaggerated relative to other structures or portions for illustrative purposes and, thus, are provided to illustrate the general structures of the present subject matter. Furthermore, relative terms such as “upper,” “lower,” “top,” “bottom,” “on” or “above” are used herein to describe one structure's or portion's relationship to another structure or portion as illustrated in the figures. It will be understood that relative terms such as “upper,” “lower,” “top,” “bottom,” “on” or “above” are intended to encompass different orientations of the apparatus in addition to the orientation depicted in the figures. For example, if the apparatus in the figures is turned over, structure or portion described as “above” other structures or portions would now be oriented “below” the other structures or portions. Likewise, if the apparatus in the figures is rotated along an axis, stricture or portion described as “above”, other structures or portions would now be oriented “next to” or “left of” the other structures or portions. Like numbers refer to like elements throughout.

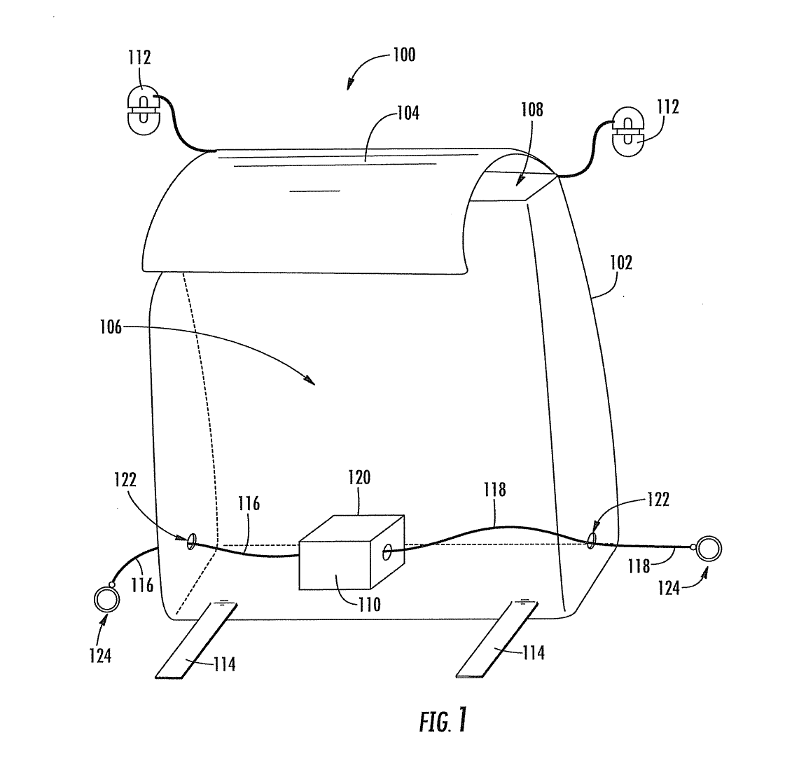

FIG. 1 shows one embodiment of wheelchair foot pedal tethering and storage device generally designated 100 for use with wheelchair foot pedals. Device 100 may prevent loss of one or more wheelchair foot pedals. Device 100 can comprise a body with a tethering portion and a storage portion for facilitating easy detachment and storage of wheelchair foot pedals. Removed foot pedals can be stored locally to the wheelchair in the storage portion of the apparatus, thereby preventing loss. By storing detached wheelchair foot pedals local to the wheelchair, the probability that the foot pedals can become separated from the main body of the wheelchair is greatly reduced, thereby decreasing the opportunity for misplacement and/or loss of the foot pedals.

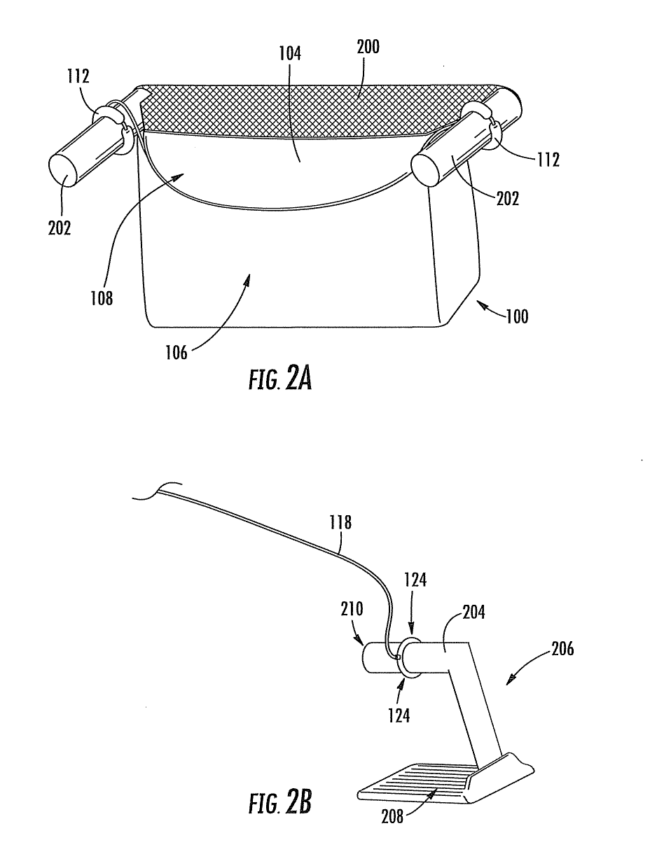

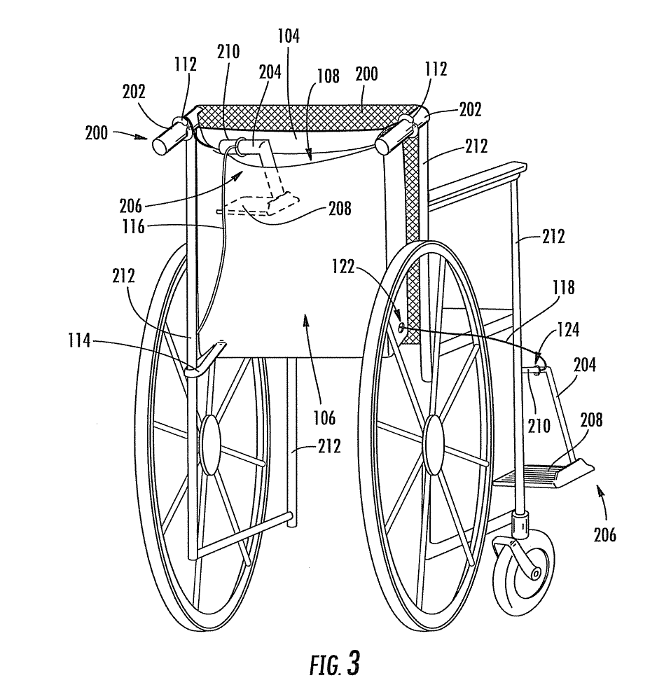

Referring to FIG. 1, loss prevention device 100 can comprise a body 102 for use with a wheelchair 200 (FIGS. 2A-3). Body 102 can comprise a deformable material having a flap 104 that can extend over a storage portion generally designated 106. Storage portion 106 can be accessible via opening 108. Body 102 can further comprise a tethering portion or device 110 that can be disposed on or within body 102. FIG. 1 illustrates tethering device 110 disposed within storage portion 106 of body 102. Tethering device 110 can be attached to body 102 using any suitable method and can be formed integral with storage portion 106 of body 102. Body 102 can comprise an upper portion having at least one attachment member 112 and a lower portion having at least one fastening member 114. Attachment member 112 can comprise an attachment portion and any suitable type of tether such as a cord or cable and can be configured for removably attaching or connecting to a handle of wheelchair 200 (See FIG. 2A). For example, in one aspect attachment member 112 can be slidable to slidably engage over a handle of wheelchair 200. In other aspects, attachment member 112 can threadingly engage, elastically engage, or clamp over the handle of wheelchair 200. Fastening member 114 can be configured for removably connecting to a frame 212 of wheelchair 200 (FIG. 3). For example, fastening member 114 can comprise a fastener that can loop around the frame of wheelchair and become secured thereto using a snap or hook and loop type fastening or any suitable closing mechanism such that device 100 can be removably attached to a back of wheelchair 200.

Tethering device 110 can, for example and without limitation, comprise a first connecting member 116 and a second connecting member 118. In one aspect, first and second connecting members 116 and 118 can comprise retractable members, for example, including but not limited to a retractable cord, string, cable or wire which can be retracted into a housing 120 of tethering device 110 when retraction is triggered via pulling or otherwise. Connecting members 116 and 118 which can be retractable may be advantageous as retraction eliminates cumbersome, long strings or cords which could interfere with or become tangled with portions of wheelchair 200 and/or a user of wheelchair. Tethering device 110 can comprise, for example, any suitable structure or mechanism that can bias first and second connecting members 116 and 118 and provide retraction force to pull them inside, at least substantially, of housing 120. Spring-loaded retractable members can be used as can be appreciated by those of skill in the art which can retract first and second connecting members 116 and 118 into housing 120 of tethering device 110 to facilitate easy, non-cumbersome storage of wheelchair foot pedals. First and second connecting members 116 and 118 can extend externally from storage portion 106 via one or more openings 122 in body 102. First and second connecting members 116 and 118 can connect tethering device 110 to one or more removable wheelchair foot pedals (FIG. 2B).

First and second connecting members 116 and 118 can each comprise a coupling end generally designated 124 for coupling or securing to wheelchair foot pedals. Coupling ends 124 can for example comprise a loop enclosure which can fittingly and/or elastically engage about a portion of wheelchair foot pedals such that the foot pedals can be retracted into pouch via tethering device 110. In one aspect, coupling ends 124 can comprise a clamp for fittingly engaging with wheelchair foot pedals. Any suitable size, shape, or orientation of coupling end 124 which can securely couple to wheelchair foot pedals is contemplated.

Wheelchair foot pedals can be movable between an attached position and a detached position using tethering device 110. For example, upon removal of a foot pedal from the wheelchair, tethering device 110 can retract first and second connecting members 116 and 118 and foot pedals can be placed in storage portion 106 of device 100. When in the detached position, the foot pedals can fit into and become securely retained within storage portion 106 of device 100. In another aspect, upon removal of a foot pedal from the wheelchair, tethering device 110 can be activated to cause or provide the retraction force, such as by any technique suitable and known to those of skill in the art. For example, and without limitation, tethering device 110 can be configured such that pulling on first and second connecting members 116 and 118 causes or provides the retraction force and foot pedals can be placed in storage portion 106 of device 100. Again, when in the detached position, the foot pedals can fit into and become securely retained within storage portion 106 of device 100.

FIG. 2A illustrates device 100 disposed on a portion of wheelchair 200. For example, attachment members are illustrated 112 as elastically deforming and/or clamping about handles 202 of wheelchair 200 to secure apparatus 100 to the back of wheelchair 200. Opening 108 of storage portion 106 can be configured for securely holding one or more foot pedals when pedals have been removed from the body of wheelchair 200. FIG. 2B illustrates coupling end 124 engaging about an elongated portion 204 of a removable foot pedal generally designated 206. Removable foot pedal 206 can comprise a foot rest portion 208 for supporting a wheelchair user's foot and a connecting end 210 which can connect to a frame 212 of wheelchair 200. Coupling end 124 can secure about elongated portion 204 of removable foot pedal proximate connecting end 210 such that connecting member 118 does not tangle or otherwise interfere with foot rest portion 208. Upon detachment of foot pedal 206 from wheelchair, connecting member 118 can be retracted by tethering device 110 and pedal can be placed in storage portion 106 thereby storing the pedal locally to wheelchair 200 and preventing loss of foot pedal 206.

FIG. 3 illustrates device 100 positioned over and/or secured on wheelchair, generally designated 200. FIG. 3 illustrates foot pedal 206 positioned in storage portion 106 of apparatus 100 after removal of pedal from wheelchair frame 212. Device 100 can comprise a semi-permanent collapsible device attached to wheelchair 200 at handles 202 and wheelchair frame 212. For example, attachment members 112 can fittingly engage wheelchair handles 202 while fastening members 114 can engage wheelchair frame 212. A first end of first connecting member 116 can be retracted taut by tethering device 110 such that excess length of connecting member is within housing 120 of tethering device 110 which is disposed in storage portion 106. A second, coupling end 124 of first connecting member 116 can be attached to wheelchair foot pedal 206 as it is stored in storage portion 106. Foot pedal 206 can be removed from storage portion 106 by pulling, or extending connecting member 116 from tethering device 110 and re-attaching pedal to frame 212.

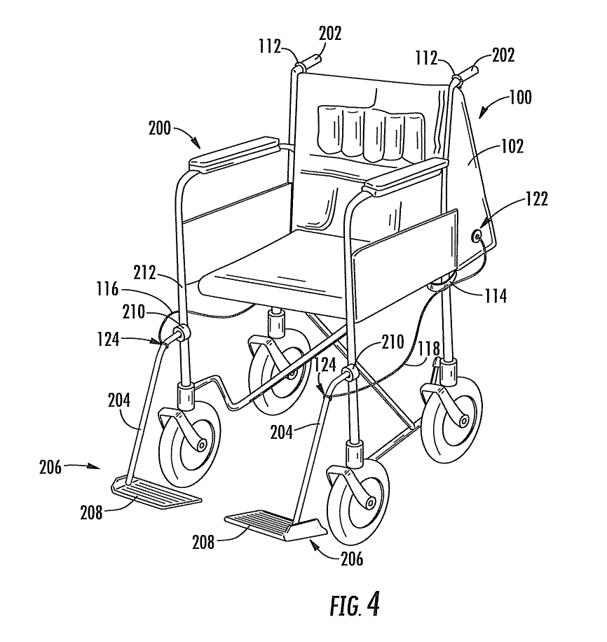

FIG. 4 illustrates a front perspective view of device 100 disposed on wheelchair 200. First connecting member 116 can extend through opening 122 of body 102 and connect to a portion of foot pedal 206 via coupling end 124. Coupling end 124 can be configured in any suitable manner to removable and releasably attach to any foot pedal of a wheelchair. As shown in some of the figures and as described previously, coupling end 124 can comprise any suitable structure for coupling to a foot pedal such as foot pedal 206. Device 100 can prevent pedal 206 from being completely detached from the main body, or frame 212 of wheelchair 200. That is, pedals 206 can be removed from their attached positions and stored in another location on the wheelchair, such as within storage portion 106. Once installed, device 100 can be collapsible and folded with wheelchair 200 as one unit. The wheelchair pedals 206, 208 can be contained within the pouch, thereby capable of being in connection with the wheelchair at all times, even when in the detached position.

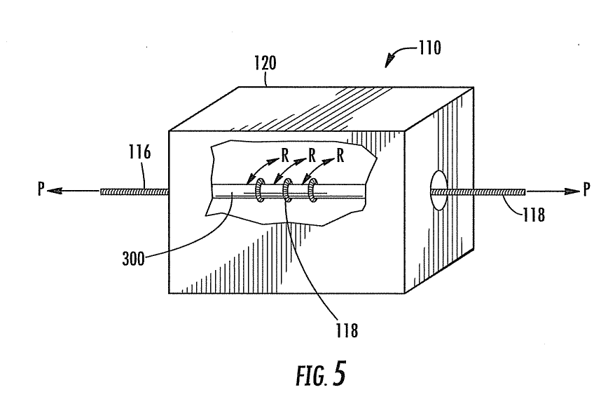

FIG. 5 illustrates tethering device 110. In one aspect, tethering device 110 can for example comprise housing 120 surrounding a reel 300. Reel 300 can be configured and/or biased to wind (retract) and unwind (extend) excess portions of connecting members 116 and 118 by rotating clockwise or counterclockwise in the directions indicated by arrows R. Connecting members 116 and 118 can unwind from reel 300 by pulling connecting members in the directions indicated by the arrows P. Connecting members can be retracted into housing 120 by again pulling in the direction indicated by the arrows such that a retraction module (not shown) causes reel 300 to rotate in an opposite direction such that the connecting members 116 and 118 wind about reel 300 and become retracted in housing 120. As noted, any other suitable structure or configuration could be used.

Embodiments of the present disclosure shown in the drawings and described above are exemplary of numerous embodiments that can be made within the scope of the present subject matter. It is contemplated that the configurations of a flexible foot can comprise numerous configurations other than those specifically disclosed.

What is claimed is:

1. An wheelchair foot pedal tethering and storage device for use with one or more wheelchair foot pedals, the device comprising:
a body comprising a storage portion;
at least one tethering device disposed within the body, the tethering device having a first connecting member connected to at least a first wheelchair foot pedal; and
wherein the first wheelchair foot pedal is movable from an attached position to a detached position, and wherein the first wheelchair foot pedal can be placed into the storage portion when in the detached position.

2. The device according to claim 1, wherein the tethering device further comprises a second connecting member connected to a second wheelchair foot pedal.

3. The device according to claim 2, wherein the second wheelchair foot pedal is movable from an attached position to a detached position, and wherein the second wheelchair foot pedal can be placed into the storage portion when in the detached position.

4. The device according to claim 1, wherein the body comprises an upper portion comprising at least one attachment member.

5. The device according to claim 4, wherein the body comprises a lower portion comprising at least one fastening member.

6. The device according to claim 5, wherein the attachment member connects to a wheelchair handler, and wherein the fastening member connects to wheelchair frame.

7. An device to prevent loss of one or more wheelchair foot pedals, the apparatus comprising:
a body comprising an upper portion with at least one attachment member and a lower portion with at least one fastening member;
a tethering device disposed in the body; and
wherein the body is attached to a back of a wheelchair when the attachment member connects to a wheelchair handle, and the fastening member connects to a wheelchair frame.

8. The device according to claim 7, wherein the body further comprises a storage portion.

9. The device according to claim 8, wherein the tethering device comprises a first connecting member for connecting to a first wheelchair foot pedal.

10. The device according to claim 9, wherein the tethering device comprises a second connecting member for connecting to a second wheelchair foot pedal.

11. The device according to claim 10, wherein the storage portion is configured to receive the first and second wheelchair foot pedals.

12. A method of preventing loss of wheelchair foot pedals, the method comprising:
providing an device for attaching to a wheelchair, the apparatus comprising:
a body comprising a storage portion, an attachment member, and a fastening member;
a tethering device disposed in the body, the tethering device comprising first and second connecting members for connecting to first and second wheelchair foot pedals;
attaching the body to the back of a wheelchair by connecting the attachment member to a wheelchair handle, and by connecting the fastening member to a wheelchair frame;
detaching the first and second wheelchair foot pedals from the wheelchair; and
placing the wheelchair foot pedals into the storage portion.

13. The method according to claim 12, further comprising retracting portions of the first and second connecting members into the tethering device.

14. A method of preventing loss of wheelchair foot pedals, the method comprising:
attaching a tethering device comprising at least one connecting member to a wheelchair, the tethering device disposed in a storage portion of a loss prevention apparatus;
connecting the first connecting member to a first wheelchair foot pedal;
detaching the first wheelchair foot pedal from the wheelchair;
retracting a portion of the first connecting member into the tethering device;
placing the first wheelchair foot pedal into the storage portion of the loss prevention apparatus.
